(19) United States
(12) Patent Application Publication
(10) Pub. No.: US 2010/0164811 A1
(43) Pub. Date: Jul. 1, 2010

(54) Solid Antenna

(75) Inventors: Shih-Chieh Cheng, Hsinchu (TW); Kuo Chang Lo, Hsinchu (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Arcadyan Technology Corp.

(21) Appl. No.: 12/644,795

(22) Filed: Dec. 22, 2009

(30) Foreign Application Priority Data
Dec. 29, 2008 (TW) 97151300

(51) Int. Cl. H01Q 1/38; H01Q 5/00

(52) U.S. Cl. 343/700 MS

(57) ABSTRACT

A solid antenna is provided in the present invention. The solid antenna configured on a substrate having an electronic circuit disposed thereon, including: an antenna body having at least one bending portion and a signal feed-in portion by which the antenna body is electrically connected to the electronic circuit and secured to the substrate, wherein the at least one bending portion is configured to be across the substrate.

### FIELD OF THE INVENTION

The present invention relates to an antenna, in particular, to a solid antenna.

### BACKGROUND OF THE INVENTION

Due to the prosperous development of the electronic technology nowadays, the sizes of electronic elements, such as the active and passive elements, are rapidly miniaturized. Such miniaturization becomes a mainstream trend applied to design various sorts of the electronic device and a technology field relevant to wireless communication is certainly not excluded therefrom. For instance, the sizes of various user equipments, such as mobile phone, USB wireless interne card and notebook computer, become as small as possible. Accordingly, the techniques relevant to the miniaturization of antenna transmitting/receiving radio frequency (RF) signals, particularly the techniques related to how to shrink a size of an antenna but without losing the communication quality and how to dispose or configure an antenna in a limited or a miniaturized space in an electronic device without degrading the communication quality, have became a critical issue for researching and developing.

Please direct to FIG. 1, which is a diagram illustrating an inverted F antenna. The inverted F antenna 10, which is a planar antenna, shown in FIG. 1 is the most popular antenna on the current communication market. The inverted F antenna 10 in FIG. 1 is made of a thin metal plate including an antenna body and a signal feed-in line 14. The antenna body further includes a radiating portion 11, a ground portion 12 and a connecting portion 13, wherein the radiating portion 11 is utilized for transmitting/receiving the RF signals to or from the atmosphere and includes a first radiating part 11a and a second radiating part 11b with different length for forming the radiating portion 11 having two inverted-F shape. The first radiating part 11a and the second radiating part 11b are respectively operated for transmitting/receiving in a frequency bands between different frequencies. The connecting portion 13 is used for connecting the radiating portion 11 and the ground portion 12. The inverted F antenna 10 is easy to be disposed in a miniaturized electronic device, since it is a thin metal plate.

However, as compared to the planar antenna, a solid antenna is not suitable to be made as a micro or miniaturized antenna. The reason is that the micro or miniaturized antenna is used for disposing in a limited, narrow and small space, so that the height of the solid antenna would be accordingly confined and significantly reduced, leading to problems, such as insufficient induced current and bad match with the vertical dipole from the access point (AP). Therefore, a miniaturized solid antenna typically has a higher voltage standing wave ratio (VSWR) that causes ill communication quality, which hardly satisfies the required benchmarks of wireless communications for IEEE 802.11a/b/g/n, Worldwide Interoperability for Microwave Access (WiMax) and Blue tooth standards.

To overcome the mentioned drawbacks of the prior art, a surface treatment method and device thereof are provided.

### SUMMARY OF THE INVENTION

In view of the defects existing in the prior art, this invention relates to provide an antenna disposed or configured by utilizing sufficiently a surplus height on the front and back side of the substrate, for increasing the height of the antenna that is miniaturized, so that the communication quality of the miniaturized antenna is accordingly enhanced. The antenna provided by the present invention is essentially suitable for being used in a micro or miniaturized antenna or in an electronic device with a micro or miniaturized antenna. The antenna provided by the present invention could be disposed or configured in a limited or constricted space but still maintains an excellent communication quality at the same time.

According to the first aspect of the present invention, a solid antenna is provided. The solid antenna configured on a substrate having an electronic circuit disposed thereon, including: an antenna body having at least one bending portion and a signal feed-in portion by which the antenna body is electrically connected to the electronic circuit and secured to the substrate, wherein the at least one bending portion is configured to be across the substrate.

According to the first aspect of the present invention, a solid antenna is provided. The solid antenna configured on a substrate having an electronic circuit disposed thereon, comprising: an antenna body having at least one bending portion and a signal feed-in portion by which the antenna body is electrically connected to the electronic circuit and secured to the substrate, wherein the at least one bending portion is configured to be across the substrate.

Preferably, the antenna body further comprises a solid structure formed by the at least one bending portion and the signal feed-in portion and at least one supporting portion secured to the substrate and supporting the antenna body.

Preferably, the substrate is a printed circuit board being one of a single-sided printed circuit board and a double-sided printed circuit board.

Preferably, the substrate has a first side and a second side opposite to the first side and the electronic circuit is disposed on the second side.

Preferably, the antenna body is one selected from a group consisting of a single band antenna, a double band antenna and a multiband antenna.

Preferably, the signal feed-in portion transmits or receives a radio frequency signal.

Preferably, the at least one bending portion is configured for increasing a height of the solid antenna.

Preferably, the antenna body is made of an alloy.

Preferably, the substrate has a specific part being under the antenna body and the specific part is retained thereon.

Preferably, the substrate has a specific part being under the antenna body and the specific part is cut off.

According to the second aspect of the present invention, a solid antenna is provided. The solid antenna configured on at least one substrate having a first side and a second side opposite to the first side, comprising: a main body disposed over a surplus height between the first and the second sides.

Preferably, the surplus height is a first height on the first side and a second height on the second side.

According to the third aspect of the present invention, an antenna is provided. The antenna configured on a substrate having a first side and a second side opposite to the first side on one of which an electronic circuit is configured, comprising: a solid body having a signal feed-in portion by which the solid body is electrically connected to the electronic circuit, secured to the substrate and configured over the first side and the second side.

Preferably, the antenna is configured in an electronic device.

Preferably, the electronic device is one selected from a group consisting of a wireless USB antenna, a wireless USB network card, a notebook computer, a wireless transceiver, a mobile phone and a telecommunication apparatus.

Preferably, the antenna is configured in a wireless transmit/receive unit (WTRU).

The foregoing and other features and advantages of the present invention will be more clearly understood through the following descriptions with reference to the drawings:

### BRIEF DESCRIPTION OF THE DRAWINGS

FIG. 1 is a diagram illustrating an inverted F antenna;

FIG. 2(a) is a diagram illustrating the first embodiment for the solid antenna from a first viewing angel according to the present invention;

FIG. 2(b) is a diagram illustrating the first embodiment for the solid antenna form a second viewing angel according to the present invention;

FIG. 3 is a diagram illustrating the second embodiment for the solid antenna according to the present invention;

FIG. 4(a) is a diagram illustrating the third embodiment for the solid antenna according to the present invention;

FIG. 4(b) is a diagram illustrating the fourth embodiment for the solid antenna according to the present invention; and

FIG. 4(c) is a diagram illustrating the fifth embodiment for the solid antenna according to the present invention.

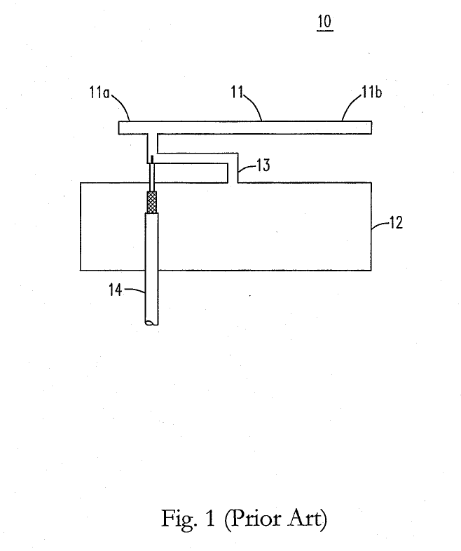

### DETAILED DESCRIPTION OF THE PREFERRED EMBODIMENT

The present invention will now be described more specifically with reference to the following embodiments. It is to be noted that the following descriptions of preferred embodiments of this invention are presented herein for the aspect of illustration and description only; it is not intended to be exhaustive or to be limited to the precise from disclosed.

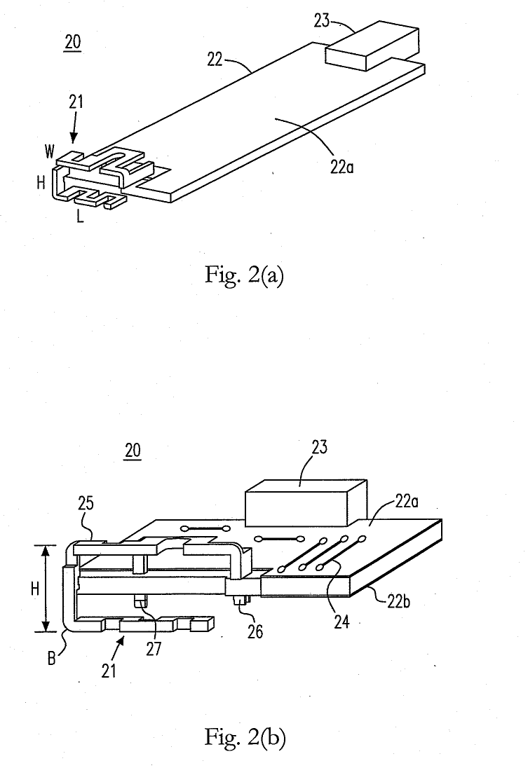

Please refer to FIGS. 2(a) and (b), which are the diagrams for respectively illustrating the first embodiment for the solid antenna according to the present invention with different viewing angels. An USB WTRU (wireless transmit/receive unit) 20 having an antenna 21 is disclosed in FIG. 2. The antenna 21 is configured on one end of a printed circuit board (PCB) 22 and a 1×1 USB interface 23 is configured on other end of the PCB substrate 22. A first side 22a of the PCB substrate 22 is the side ordinarily utilized for disposing a plurality of electronic elements including capacities, resistances and IC chips that are protruded from the first side 22a. The first side 22a is commonly recognized as a front side or an upper side as well. A second side 22b is opposite to the first side 22a and an electronic circuit 24 is printed thereon. There are legs of the above-mentioned electronic elements, solders and printed conducting wires included in the electronic circuit 24 on the second side 22b. The second side 22b is the side ordinarily deemed as a back side or a down side as well. The PCB substrate 22 is a single-sided printed circuit board or a double-sided printed circuit board. Since plural electronic elements and the electronic circuit 24 respectively deposed on the first side 22a and the second side 22b have different heights, a surplus height is accordingly formed from a casing (not shown in FIG. 2) of the USB WTRU 20 to the respective first side 22a and second side 22b for containing the plural electronic elements and the electronic circuit 24.

The antenna 21 disposed on the PCB substrate 22 has a body 25, a signal feed-in portion 26 and a supporting portion 27. The signal feed-in portion 26 and the supporting portion 27 are securely fixed to the PCB substrate 22 for supporting the body 25. The number of the supporting portion 27 is adjustable in accordance with the practice conditions, which is not limited to only one supporting portion as exemplified in this first embodiment. Usually the number of the supporting portion 27 is duly adjusted in accordance with the size of the antenna 21. The signal feed-in portion 26 is electrically connected with the electronic circuit 24 of the second side 22b for transmitting or receiving the radio frequency (RF) signals. The body 25 is essentially a solid antenna consisting of one or a plurality of bending portions B. Since the body 25 is a solid antenna, it has a length L, a width W and a height H. The height H of the body 25, formed by the bending portion B, is configured on the PCB substrate by being across the first side 22a and the second side 22b of the PCB substrate 22. Accord to the above-mentioned embodiment, the height H of the body 25 is able to be fully extended as possible by the surplus height on the PCB substrate 22, so as to obtain a higher height. Typically, in order to obtain a better match with the vertical dipole transmitted from the access point (AP) end, the height H of the body 25 is preferable to be higher or greater, so that more induced current is thus generated by the body 25, resulting in a better communication quality for the antenna 21. Therefore, for enabling a better communication quality of the antenna 21, the height H of the body 25 of the antenna 21 is preferably higher or greater.

For the convenience of illustrating the ingenuity of the present invention, a preferred embodiment showing with the specific dimensions of the respective element in the present invention is adopted as follows. However, an implementation of the present invention shall be never limited to these specific dimensions. Usually, for an USB WTRU 20, in particular to an USB antenna device having 1×1 USB interface, a thickness of the PCB substrate 22 thereof is preferably approaching to 1 mm±1 mm. Since the upper space on the first side 22a has to contain the electronic elements having significant height, the surplus height of the upper space or the first side 22a is preferably in dimension of 10 mm±2 mm. The down space on the second side 22b has to merely contain the legs or solders being having height more flatter than that of the electronic elements, the surplus height of the down space or the second side 22b is preferably in dimension of 5 mm±2 mm. While the body 25 is implemented in accordance with the embodiment illustrated as the above-mentioned disclosures for rendering the height H of body 25 spanning over the first side 22a and the second side 22b of the PCB substrate 22, under the above-mentioned assumed conditions, it is possible that the antenna 21 can preferably have the height H up to 21 mm (which is never used for limiting the other possible dimensions of the height H according to the disclosure of the present invention). Once the height H of the antenna 21 is increased, the communication quality of the USB WTRU 20 is thus accordingly and significantly increased. With respect to the different sizes of antenna relevant products, the above-mentioned surplus height for the USB WTRU 20 is correspondingly varied so that the height H for the body 25 or the antenna 21 correspondingly varied as well. Therefore, it is possible to obtain a dimension of height greater or smaller than the above-mentioned one.

The antenna 21 is preferably exemplified with a single band low-frequency solid metal antenna having an operating frequency band in a range of 2.4 GHz to 2.7 GHz. The thickness of the antenna 21, made of an iron-made alloy, is preferably in dimension of 0.6 mm. The length L and the width W of the antenna 21 are preferably in dimensions of 10.0 mm and 5.0 mm respectively. However, the implementation of the present invention is never limited thereto. The antenna 21 is also a single band antenna, a double band antenna or a multiband antenna. The concept introduced in the present invention is able to be applied to any of a miniaturized antenna, so as to increase the height of the antenna as possible as it can be and to correspondingly increase the communication quality. The present invention is never limited to be applied to an USB WTRU having 1×1 USB interface. The present invention is additionally applicable to other diverse USB WTRU having 1×N USB interface. After experimenting, it is proved that an antenna to be disposed or configured on a substrate in accordance with the disclosure of the present invention has a communication quality fully satisfying benchmarks for the wireless communication in IEEE 802.11a/b/g/n, WiMax or Blue tooth. In particular, the antenna to be disposed or configured in according to the disclosure of the present invention is suitable for being configured or disposed in a electronic device having a micro or miniaturized antenna, such as a wireless USB antenna, a wireless USB network card, a notebook computer, a wireless transceiver, a mobile phone or a telecommunication apparatus and accordingly, the antenna to be disposed or configured in according to the disclosure of the present invention is suitable for being configured or disposed in a wireless transmit/receive unit (WTRU) as well.

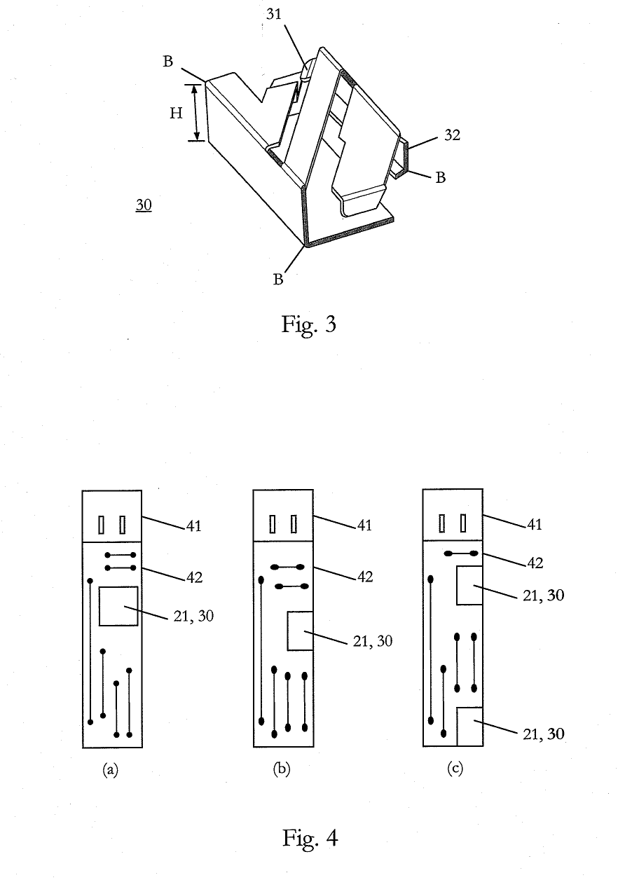

Please refer to FIG. 3, which is a diagram illustrating the second embodiment for the solid antenna according to the present invention. A double band antenna 30 is disclosed in FIG. 3. The double band antenna 30 has a signal feed-in portion 31, a supporting portion 32 and a plurality of bending portions B. The double band antenna 30 transmits or receives the RF signals through the signal feed-in portion 31 and securely fixed to the substrate (not shown in FIG. 3) through the supporting portion 32. By disposing the double band antenna 30 to the substrate thereof in accordance with the above-mentioned implementations to render the height H of the double band antenna 30 over the first side and the second side of the substrate, the height H of the double band antenna 30 could be accordingly increased correspondingly. Therefore, the antenna architecture utilizing the surplus height could also be applied to a multiband antenna. By disposing the multiband antenna to the substrate thereof in accordance with the above-mentioned implementations to render the height H of the multiband antenna over the first side and the second side of the substrate, the height H of the multiband antenna is accordingly increased correspondingly.

Please refer to FIGS. 4(a), 4(b) and 4(c), which are the respective diagrams for respectively illustrating the third, fourth and fifth embodiments for the solid antenna according to the present invention. The antenna as disclosed in the present invention is not limited to be disposed or configured at the short side of the substrate, but is able to be disposed or configured at the long side, inside or central part of the substrate. According to the illustration of FIGS. 4(a), 4(b) and 4(c), it is known that the antennas 21 and 30 could be disposed or configured at the central part, the long side or any part of the substrate 42 with an USB interface 41 respectively.

In the above-mentioned embodiments, the height of the antenna is not limited to be across only one substrate, but also to be across multiple substrates. In nowadays, for miniaturizing size of an electronic device, a plurality of the substrates might be vertically stacked in an electronic device. An antenna in an electronic device having such stacked substrates could also be disposed or configured across the stacked substrates in accordance with the above-mentioned implementations, to form a solid antenna having an increased height by utilizing the surplus height on the first side and second side of the stacked substrates.

In the above-mentioned embodiments, a specific part of the substrate under the antenna body could be retained or cut off.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims that are to be accorded with the broadest interpretation, so as to encompass all such modifications and similar structures. According, the invention is not limited by the disclosure, but instead its scope is to be determined entirely by reference to the following claims.

What is claimed is:

1. A solid antenna configured on a substrate having an electronic circuit disposed thereon, comprising:
an antenna body having at least one bending portion and a signal feed-in portion by which the antenna body is electrically connected to the electronic circuit and secured to the substrate,
wherein the at least one bending portion is configured to be across the substrate.

2. The solid antenna according to claim 1, wherein the antenna body further comprises a solid structure formed by the at least one bending portion and the signal feed-in portion and at least one supporting portion secured to the substrate and supporting the antenna body.

3. The solid antenna according to claim 1, wherein the substrate is a printed circuit board being one of a single-sided printed circuit board and a double-sided printed circuit board.

4. The solid antenna according to claim 1, wherein the substrate has a first side and a second side opposite to the first side and the electronic circuit is disposed on the second side.

5. The solid antenna according to claim 1, wherein the antenna body is one selected from a group consisting of a single band antenna, a double band antenna and a multiband antenna.

6. The solid antenna according to claim 1, wherein the signal feed-in portion transmits or receives a radio frequency signal.

7. The solid antenna according to claim 1, wherein the at least one bending portion is configured for increasing a height of the solid antenna.

8. The solid antenna according to claim 1, wherein the antenna body is made of an alloy.

9. The solid antenna according to claim 1, wherein the substrate has a specific part being under the antenna body and the specific part is retained thereon.

10. The solid antenna according to claim 1, wherein the substrate has a specific part being under the antenna body and the specific part is cut off.

11. A solid antenna configured on at least one substrate having a first side and a second side opposite to the first side, comprising:
a main body disposed over a surplus height between the first and the second sides.

12. The solid antenna according to claim 11, wherein the surplus height is a first height on the first side and a second height on the second side.

13. An antenna configured on a substrate having a first side and a second side opposite to the first side on one of which an electronic circuit is configured, comprising:
a solid body having a signal feed-in portion by which the solid body is electrically connected to the electronic circuit, secured to the substrate and configured over the first side and the second side.

14. The antenna according to claim 13 being configured in an electronic device.

15. The antenna according to claim 14, wherein the electronic device is one selected from a group consisting of a wireless USB antenna, a wireless USB network card, a notebook computer, a wireless transceiver, a mobile phone and a telecommunication apparatus.

16. The antenna according to claim 13 being configured in a wireless transmit/receive unit (WTRU).
